(19) United States
(12) Patent Application Publication
(10) Pub. No.: US 2004/0179651 A1
(43) Pub. Date: Sep. 16, 2004

(54) Automated quality control for digital radiography

(75) Inventors: Xin Tong, Santa Clara, CA (US); Alexander Berestov, San Jose, CA (US)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/385,451

(22) Filed: Mar. 12, 2003

(51) Int. Cl. H05G 1/64

(52) U.S. Cl. 378/98.8

(57) ABSTRACT

A digital radiographic system in which a digital detector captures digital radiographic image data based on exposure of a patient to x-ray energy from an x-ray source, and assesses the acceptability of the digital radiographic image data at a time before the radiographic protocol has otherwise ended. Additionally, the digital radiographic system signals whether the digital radiographic image data is unacceptable based on the assessment, and allows for the initiation of a retake. The assessment may be made based on acceptability of the exposure and/or based on the acceptability of motion artifacts in the image. If the image is unacceptable, the technologist is alerted that a re-image is needed, with the alert being made in real-time immediately after the image is captured.

### BACKGROUND OF THE INVENTION

1. Field of the Invention

The present invention concerns digital radiography, and in particular concerns real-time or near real-time determination of acceptability in digital radiographs so as to provide an opportunity for re-imaging in the event that the radiograph is not acceptable.

2. Description Of The Related Art

With recent advances in large-area digital x-ray detector technology, hospitals and imaging centers are in the process of completing a transition from conventional film-based imaging to digital radiography. Digital radiography is advantageous since images are captured originally in digital form and are available for near-instantaneous viewing, processing, enhancement and transmission to remote locations.

Quality control is an important aspect for any radiographic technique, including digital radiography. Quality control testing is routinely performed, so as to ensure proper functionality of radiographic equipment, such as proper application of radiation dose, calibration of exposure response, spatial resolution and noise characteristics. Phantoms are often employed to measure the system response in the calibration process.

Even if the equipment is functioning properly, however, patient movement or an incorrect setting can cause an individual radiograph to be blurred, overexposed or underexposed. For example, consider a patient undergoing a radiographic protocol, such as a lateral lumbar spinal examination or a postero-anterior (PA) chest x-ray. Even with properly functioning equipment, an individual image might be captured in which there is underexposure or overexposure, or in which the patient has moved causing a blurred image. In conventional systems, it might take several minutes before a technologist or technician views the image and determines that a re-image is necessary. In the meantime, however, the patient has completed the radiological protocol and might have already left the premises. Therefore, significant time is lost before a re-image can be made.

### SUMMARY OF THE INVENTION

It is an object of the invention to address the foregoing, by providing real-time or near real-time assessment of the acceptability of digital radiographs, with the assessment being made sufficiently soon after the digital radiograph is captured that a re-image can be made while the patient is still undergoing the radiographic protocol.

Thus, in one aspect, the invention is a digital radiographic apparatus including a source of x-ray energy and a digital detector for capturing digital radiographic image data based on exposure of the patient to x-ray energy from the source. A signal control unit assesses acceptability of the digital radiographic image data at a time before the radiographic protocol has otherwise ended, and signals whether the digital radiographic image data is unacceptable based on the assessment.

In preferred aspects, the assessment is made immediately after capture of the digital radiographic image data. The assessment of acceptability is preferably an assessment of acceptable exposure and/or an assessment of whether there has been patient movement during capture of the image. Exposure can be assessed through calculation of image contrast or image histogram, and a comparison of the calculated amount with contrast or histogram data typical for the radiographic protocol. Motion can be assessed through edge analysis of structure in the radiographic image or of artificial landmarks placed in the image, and comparison of the detected edges with expected widths therefor.

If the image is deemed unacceptable, then a display is preferably made to the operator signaling unacceptability of the image, and allowing initiation of a re-image. The reason for unacceptability is also preferably displayed, so that appropriate adjustments may be made. For example, in a case where exposure is deemed unacceptable, exposure adjustments can be made at the source. Likewise, if the reason for unacceptability is motion, the patient can be advised to remain more still during the protocol.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

FIG. 1 depicts an example of a physical embodiment of the present invention.

FIG. 2 depicts a block diagram of how automated quality control of digital radiography may be employed according to the present invention.

FIG. 3 is a flow chart depicting the process of assessing acceptability of the digital radiographic image data.

### DETAILED DESCRIPTION OF THE PREFERRED EMBODIMENTS

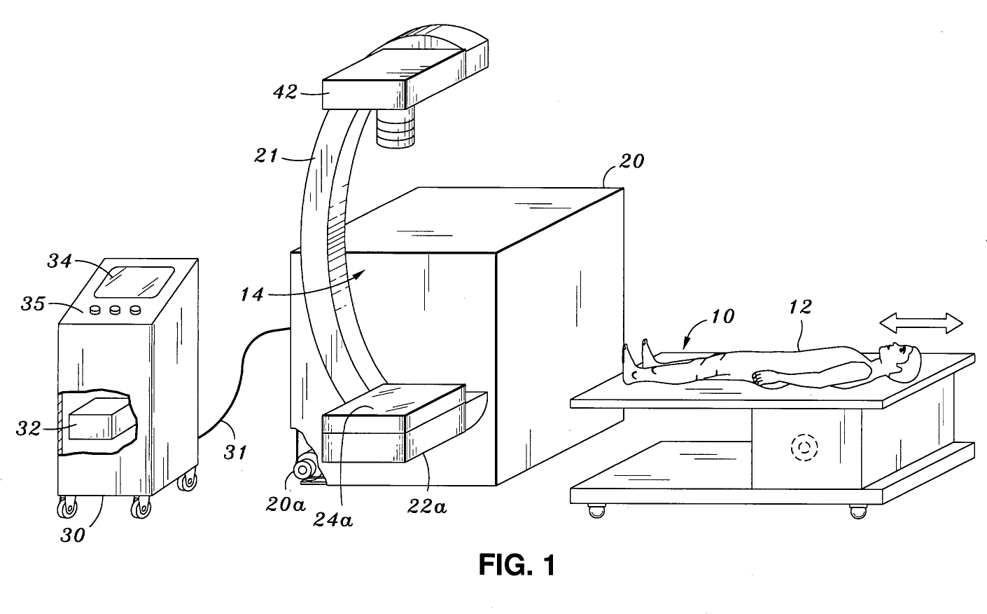

FIG. 1 depicts an example of a physical embodiment of the present invention. A digital radiography apparatus includes portable patient support 10 for holding a subject 12 in the examination region 14. The subject 12 could be an object such as a phantom, or a human patient. A x-ray support 20 supports a rotatable cantilever arm 21, which holds x-ray source 42 and gamma camera head 22a above and below examination region 14, respectively. A motor 20a is provided to rotate cantilever arm 21 around the subject 12. Digital detector 24a is mounted respectively on the radiation receiving face of camera head 22a.

Digital radiographs are collected using processes conventional in the art according to a radiographic protocol selected by the technologist in conformity with a desired diagnostic procedure. Such a protocol often involves capture of plural radiographs at multiple different positions and orientations of the patient, such as an examination of a hand or wrist, or a lumbar spinal examination for scoliosis. The captured radiographs are transferred from digital detector 24a to signal control unit 32, housed in signal control unit housing 30, via data link 31. Data link 31 is a physical cable connection, but in an alternative embodiment it may be a wireless network connection, as preferred. The collection and transfer of digital radiographs occurs in real-time or near-real-time, at a time before the radiographic protocol has otherwise ended.

Signal display unit 34 and operator control unit 35 are connected to signal control unit 32. Signal display unit 34, which acts in response to signaling from the signal control unit 32 for displaying to an operator that a radiographic image is unacceptable and for allowing initiation of a re-image, may be a bank of gauges or indicators, a computer monitor on which messages can be displayed, or a speaker through which sounds are produced, or any combination thereof. Although gauges may be used, in its preferred embodiment signal display unit 34 is a computer monitor, which allows broader messaging and display capability than other types of indicators. Operator control unit 35 receives input from the operator via conventional computer keyboard or push-button-type controls or knobs, allowing the operator to alter the operation and settings of the digital radiography apparatus during a radiographic protocol. Operator control unit 35 is integrated with signal display unit 34 as a touch-screen computer monitor, allowing real-time display and input of radiological settings prior to the termination of the radiographic protocol.

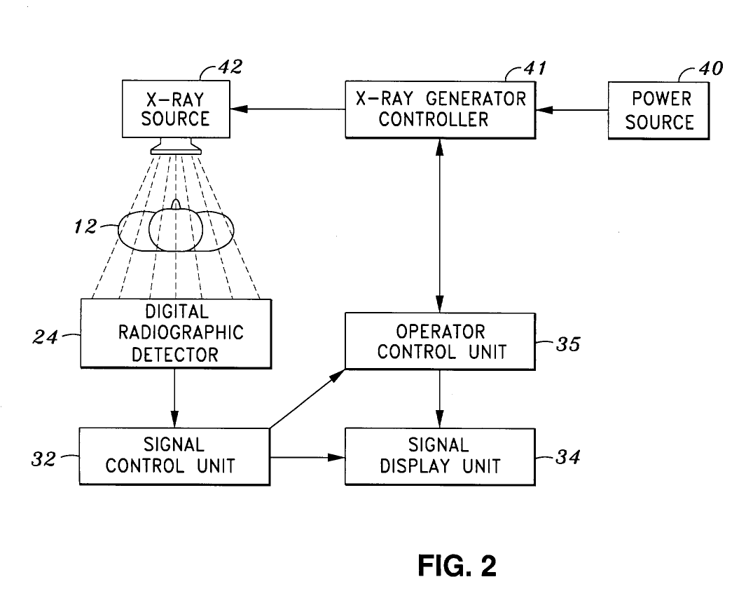

FIG. 2 depicts a block diagram of how automated quality control of digital radiography is employed according to the present invention. At the commencement of the radiographic protocol, an x-ray source 42 irradiates a particular part of a subject 12 with a beam of x-rays. The x-rays pass through the subject and are captured by a digital detector 24 based on the exposure of the subject 12 to x-ray energy from the x-ray source 42. Although FIG. 2 depicts the collection of patient image data, the subject can also be an inanimate object or a phantom as well. Digital detector 24 sends the digital radiographs to signal control unit 32, which performs calculations on the digital data, as described below. Both the operator control unit 35 and the signal display unit 34 receive values resulting from calculations performed in the signal control unit 32. Signal display unit 34 alerts the operator of the digital radiography apparatus, by displaying messages or lights, or producing sounds, or both, immediately after capturing and performing calculations on the digital radiographic image data, and allows for the initiation of a re-image. The invention may optionally be configured so that assessments of unacceptability are indicated by an absence of an alert.

After receiving a re-image request from the operator of the digital radiography apparatus, operator control unit 35 instructs both signal display unit 34 and x-ray generator controller 41, powered by a power source 40, on the settings specified by the operator. The signal display unit 34 may alert the operator to any changes made by the operator control unit 35. Again, the invention may optionally be configured so that faults are indicated by an absence of an alert.

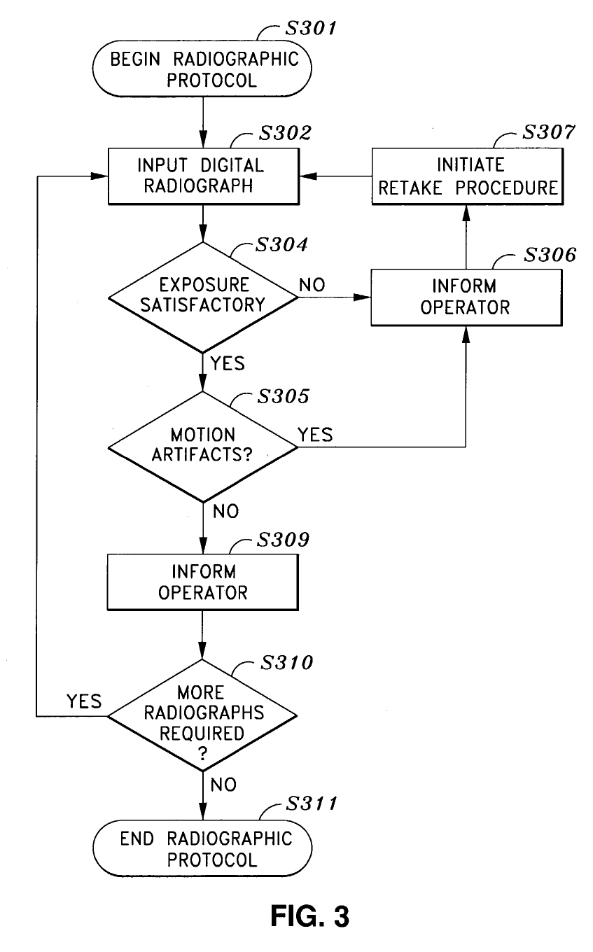

The present invention is able to perform automated quality control for digital radiography by assessing acceptability of digital radiographic image data in real-time or near-real-time, before the radiographic protocol has otherwise ended. FIG. 3 describes the series of steps performed by the signal control unit 32 to assess acceptability according to one embodiment of the invention. The operation begins when digital radiographs are input to the signal control unit 32 from the digital detector 24 (step S302). The digital radiographs are input immediately after capture so as to provide an assessment of quality in real-time or near-real-time, and permit re-imaging of defective radiographs before patient has otherwise completed a radiographic protocol.

Once the digital radiographs are input to the signal control unit 32, they are processed to assess whether exposure is acceptable (step S304). The exposure level can be assessed for acceptability through calculation of image contrast or image histogram, and comparison of the calculated amount with contrast or histogram data typical for the radiographic protocol. Alternately, the digital radiograph can be compared to other, known acceptable digital radiographs. If the exposure level is assessed as unacceptable, the signal display unit 34 informs the operator of the digital radiographic apparatus of the unacceptable exposure (step S306), and initiates a retake procedure (step S307). If the exposure level is assessed as acceptable, the signal control unit 34 proceeds to another acceptability assessment (step S305). The signal display unit 34 informs the operator of the reasons for this assessment immediately after capture of the digital radiographic image data.

If a retake procedure is initiated (step S307), the operator is allowed to manipulate the settings of the x-ray generator controller 41 by inputting new settings through the operator control unit 35. If new settings are input, they are displayed on the signal display unit 34, and the new digital radiographs are created as described above (step S302). By assessing acceptability in real-time or near-real-time and retaking digital radiographs prior to the end of the radiographic protocol, the present invention avoids the lengthy process of having the technologist manually determine whether a retake is necessary, locating the patient, and having the patient dress and undress.

Once exposure level is assessed as acceptable, the digital radiograph is checked for motion artifacts (step S305). Detecting motion artifacts is more complicated than assessing exposure, since motion artifacts can be caused by global motion (i.e. the patient or x-ray source moving), or localized motion (i.e. involuntary movement of a body part). Motion artifacts can be assessed for acceptability using software means through edge analysis of structure in the radiographic image, or of artificial landmarks placed in the image, and comparison of the detected edges with expected widths. One such software method, the preferred embodiment, involves analyzing edges in the radiographic image, and identifying motion artifacts where widths of certain landmark edges are wider than expected. Alternatively, markers can be placed on the patient and used in the analysis instead of or in addition to landmark edges. Using this method, motion artifacts appear when the markers do not appear as sharp points in the image but rather as short line segments, or other complex shapes. If there are motion artifacts, the signal display unit 34 preferably informs the operator of the digital radiographic apparatus of the motion artifacts (step S306), and initiates a retake procedure (step S307). The signal display unit 34 preferably informs the operator of the reasons for this assessment immediately after capture of the digital radiographic image data.

If there are no motion artifacts, the signal display unit 34 informs the operator that the digital radiographic image data has been assessed acceptable (step S309). Although an audible or visual alert is preferred, the acceptability of a radiographic image can be signaled by the absence of an alarm sound or displayed message or other indication. The signal display unit 34 informs the operator of this assessment immediately after capturing and performing calculations on the digital radiographic image data.

The alert indicating that there are no motion artifacts and that exposure has been assessed as acceptable informs the operator of the digital radiography apparatus that they may proceed to the next stage of the radiographic protocol (step S310). Typically, this step involves moving the patient or subject 12 so as to collect digital radiographic data from a different viewpoint or perspective, reinitiating the collection of digital radiographs, as discussed above in step S302. Alternatively, if the operator has been alerted to the acceptability of the current radiograph and no additional radiographs are required, the radiographic protocol ends (step S311). At this point, the operator can inform a patient to get off the patient support 10, get dressed and leave, or the operator can remove an inanimate subject 12 from examination region 14.

Although FIG. 3 is the preferred embodiment of the present invention, in that both an exposure test and a motion artifact test are performed, other quality control tests may be added to or substituted for the preferred tests. Additionally, the tests do not have to occur in any required order.

The invention has been described With particular illustrative embodiments. It is to be understood that the invention is not limited to the above-described embodiments and that various changes and modifications may be made by those of ordinary skill in the art without departing from the spirit and scope of the invention.

What is claimed is:

1. A digital radiographic apparatus comprising:
a source of x-ray energy;
a digital detector for capturing digital radiographic image data based on exposure of an object to x-ray energy from said source during a radiographic protocol; and
a signal control unit for assessing acceptability of the digital radiographic image data at a time before the radiographic protocol has otherwise ended, for signaling whether the digital radiographic image data is unacceptable based on the assessment, and for allowing initiation of a retake.

2. A digital radiographic apparatus according to claim 1, wherein the assessment is made immediately after capture of the digital radiographic image data.

3. A digital radiographic apparatus according to claim 1, wherein the assessment of acceptability is an assessment of acceptable exposure.

4. A digital radiographic apparatus according to claim 3, wherein acceptable exposure is assessed through calculation of image characteristics and a comparison of the calculated characteristics corresponding to characteristics typical for the radiographic protocol.

5. A digital radiographic apparatus according to claim 1, wherein the assessment of acceptability is an assessment of whether there has been movement of the object during capture of the image.

6. A digital radiographic apparatus according to claim 5, wherein acceptable motion is assessed through edge analysis of structure in the radiographic image and comparison of detected edges with expected widths therefor.

7. A digital radiographic apparatus according to claim 6, wherein the structure comprises artificial landmarks.

8. A digital radiographic apparatus according to claim 6, wherein the structure is patient image data.

9. A digital radiographic apparatus according to claim 1, further comprising a display responsive to signaling from said signal control unit, for displaying to an operator that the image is unacceptable.

10. A digital radiographic apparatus according to claim 9, wherein the reason for unacceptability is also displayed.

11. A digital radiographic apparatus according to claim 1, wherein the assessment of acceptability is made while the patient is still undergoing the radiographic protocol.

12. An automated quality control method for digital radiography comprising the steps of:
capturing digital radiographic image data based on exposure of an object to x-ray energy from a source of x-ray energy during a radiographic protocol;
assessing acceptability of the digital radiographic image data at a time before the radiographic protocol has otherwise ended;
signaling whether the digital radiographic image data is unacceptable based on the assessment; and
allowing the initiation of a retake.

13. An automated quality control method for digital radiography according to claim 12, wherein the assessment is made immediately after capture of the digital radiographic image data.

14. An automated quality control method for digital radiography according to claim 12, wherein the assessment of acceptability is an assessment of acceptable exposure.

15. An automated quality control method for digital radiography according to claim 14, wherein acceptable exposure is assessed through calculation of image characteristics and a comparison of the calculated characteristics corresponding to characteristics typical for the radiographic protocol.

16. An automated quality control method for digital radiography according to claim 14, wherein the assessment of acceptability is an assessment of whether there has been movement of the object during capture of the image.

17. An automated quality control method for digital radiography according to claim 16, wherein acceptable motion is assessed through edge analysis of structure in the radiographic image data and comparison of detected edges with expected widths therefor.

18. An automated quality control method for digital radiography according to claim 17, wherein the structure comprises artificial landmarks.

19. An automated quality control method for digital radiography according to claim 17, wherein the structure is patient image data.

20. An automated quality control method for digital radiography according to claim 12, further comprising displaying to an operator a signal from said signal control unit, indicating that the radiographic image data is unacceptable.

21. An automated quality control method for digital radiography according to claim 20, wherein the reason for unacceptability is also displayed.

22. An automated quality control method for digital radiography according to claim 12, wherein the assessment of acceptability is made while the patient is still undergoing the radiographic protocol.
